(19) United States
(12) Patent Application Publication
(10) Pub. No.: US 2013/0125702 A1
(43) Pub. Date: May 23, 2013

(54) RACING PEDAL FOR TRACK BICYCLE

(71) Applicant: Wen-Hwa LIN, Taichung City (TW)

(72) Inventor: Wen-Hwa LIN, Taichung City (TW)

(73) Assignee: VP COMPONENTS CO., LTD., Taichung City (TW)

(21) Appl. No.: 13/298,749

(22) Filed: Nov. 17, 2011

(51) Int. Cl. B62M 3/08

(52) U.S. Cl. 74/594.6

(57) ABSTRACT

A racing pedal for a track bicycle includes a pedal body, a clamping unit and a primary strap. The pedal body has a first end, a second end and an axle near the first end. The clamping unit is movably attached to the first end of the pedal body and pivotable against the axle between a clamping position for engaging a shoe cleat and a releasing position. The clamping unit has a pulling portion and a clamping portion wherein the pulling portion is farther from the second end of the pedal body than the clamping portion is, and when the clamping unit pivots on the axle, upward tilt of the pulling portion makes the clamping portion point downward. The primary strap is positioned in the pulling portion for being looped to receive the shoe.

### BACKGROUND OF THE INVENTION

1. Field of the Invention The present invention relates to pedals for bicycles, and more particularly, to a racing pedal for a track bicycle that facilitates engaging a cyclist's shoe therewith.

2. Description of the Related Art

Track cycling, as one kind of bicycle racing sport, is usually held on specially built bowl-like velodromes using specially designed track bicycles.

For optimizing its racing performance, a track bicycle, unlike road bicycles, is a bicycle having a fixed rear hub and made without any freewheels, speed control systems and brakes so as to minimize its overall weight. In addition, a track bicycle usually has its pedals configured to engage with cleats on a cyclist's shoes so as to not only prevent the cyclist's feet from unintentionally missing or slipping off the pedals, but also leverage the cyclist's upward pulling force applied to the pedals to drive the cranks, thereby improving output and cycling speed.

U.S. Pat. No. 6,119,551 has disclosed a bicycle pedal assembly for attaching a shoe thereto via a cleat, wherein the bicycle pedal has clamping members movably mounted to the pedal body for engaging with the cleat. Theoretically, when pedaled, a track bicycle should have the clamping members gripping the cleat firmly. In practice, however, it is found that many traditional clipless pedals fail under cyclists' extreme, particularly pulling force and have their cleats disengaged from the clamping members accidentally. This defect seriously risks cyclists' safety.

In order to eliminate such a risk, some may use an additional strap to bind the foot with the pedal. However, since the strap is not well positioned, it is likely to shift and lose its function in the course where the cyclist cycles. In other words, simply binding the foot with the pedal by means of a free strap is not really helpful to enhance the engagement between the cleat and the pedal.

### SUMMARY OF THE INVENTION

In view of the insufficiency of the prior art, the objective of the present invention is to provide a racing pedal for a track bicycle that ensures reliable engagement with a cyclist's shoe.

To this end, the disclosed racing pedal has a pivot connected to a crank of the track bicycle; a pedal body pivotally connected to the pivot having a first end, a second end and an axle near the first end; a clamping unit pivotally connected to the first end of the pedal body and pivotable against the axle between a clamping position and a releasing position, wherein when the clamping unit is at the clamping position, a clamping portion thereof engages with a cleat formed at a sole of a cyclist's shoe; and a spring means serving to endow the clamping unit with a tendency to return to the clamping position, wherein the clamping unit has a pulling portion that is farther from the second end of the pedal body than the clamping portion is wherein when the clamping unit pivots on the axle, upward tilt of the pulling portion makes the clamping portion point downward and thereby holds the clamping unit at the clamping position, and the clamping unit has a primary strap positioned in the pulling portion for being looped to receive the cyclist's shoe, and the clamping unit has a primary strap positioned in the pulling portion for being looped to receive the cyclist's shoe.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is an exploded view of a racing pedal according to the present invention;

FIG. 2 is a perspective view of the racing pedal according to the present invention;

FIGS. 3 and 4 are cross-sectional views of the racing pedal according to the present invention showing its operation; and

FIG. 5 is an applied view of the racing pedal according to the present invention.

### DETAILED DESCRIPTION OF THE INVENTION

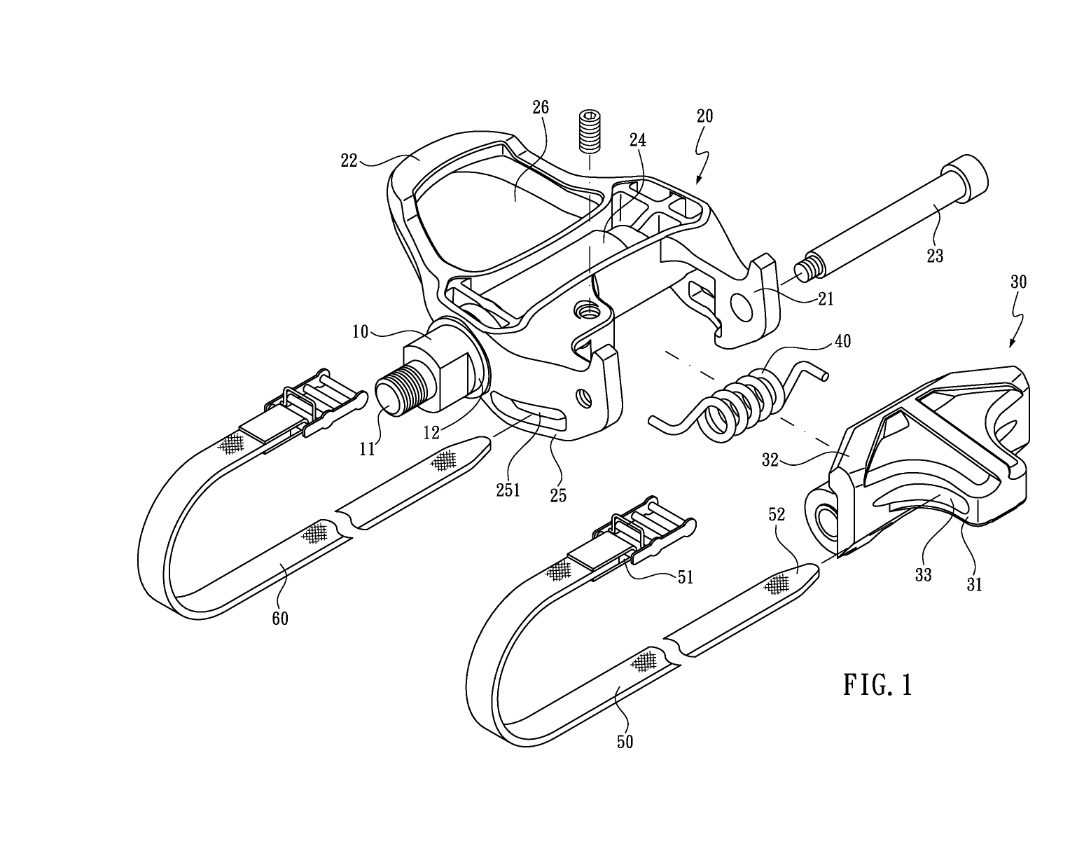

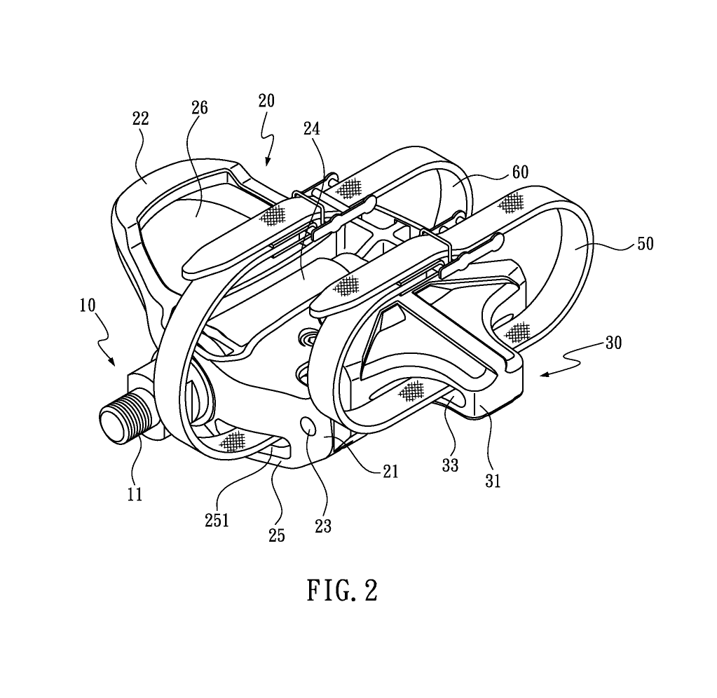

Please refer to FIG. 1 through FIG. 5 for a pedal adaptive to a track bicycle according to the present invention. The track bicycle has a crank for driving the rear wheel to rotate, and the pedal is attached to the free end of the crank. The pedal is configured to engage with a cyclist's shoe cleat 1 and comprises a pivot 10, a pedal body 20, a clamping unit 30, a spring means 40, a primary strap 50 and a secondary strap 60.

The pivot 10 has an inner end 11 connected to a crank of the track bicycle and an outer end 12. The inner end 11 may be connected to the crank by, for example, threaded means.

The pedal body 20 is pivotally connected to the outer end 12 of the pivot 10. The pedal body 20 has a first end 21, a second end 22, an axle 23 near the first end 21 of the pedal body 20, a rotatory shaft 24 located between the first and second ends 21, 22 of the pedal body 20 and a retaining portion 25. The rotatory shaft 24 is coaxial with the pivot 10. The retaining portion 25 is preferably located between the first end 21 of the pedal body 20 and the rotatory shaft 24, and is more preferably formed with a channel 251 parallel to the axle 23. In addition, for engaging the cyclist's shoe cleat 1 in position, the pedal body 20 may have a retaining hole 26 or retaining hook that fits the cleat 1.

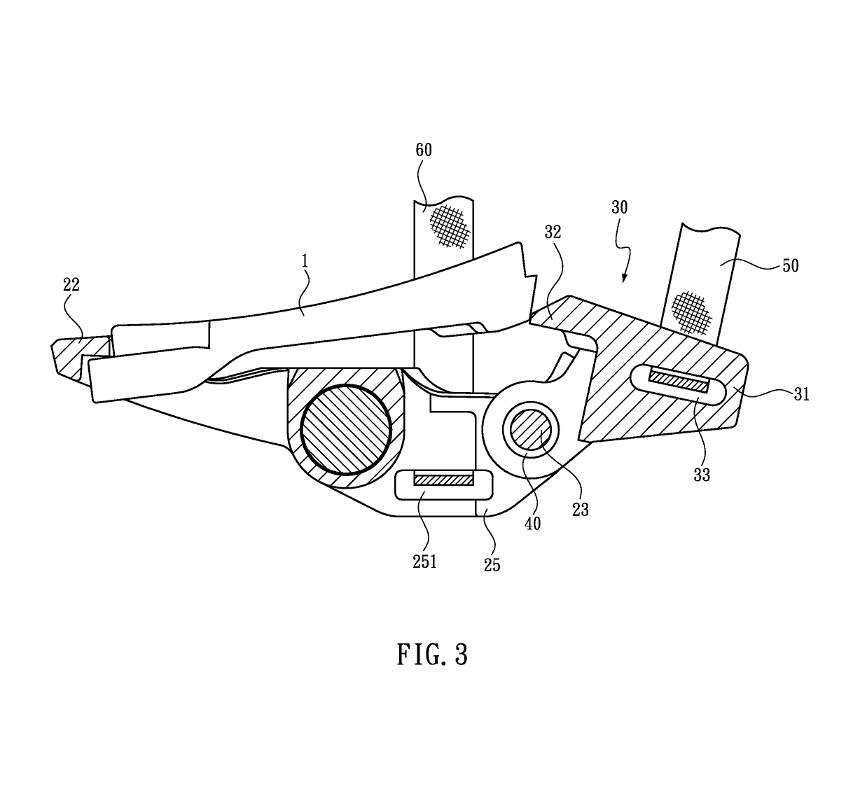

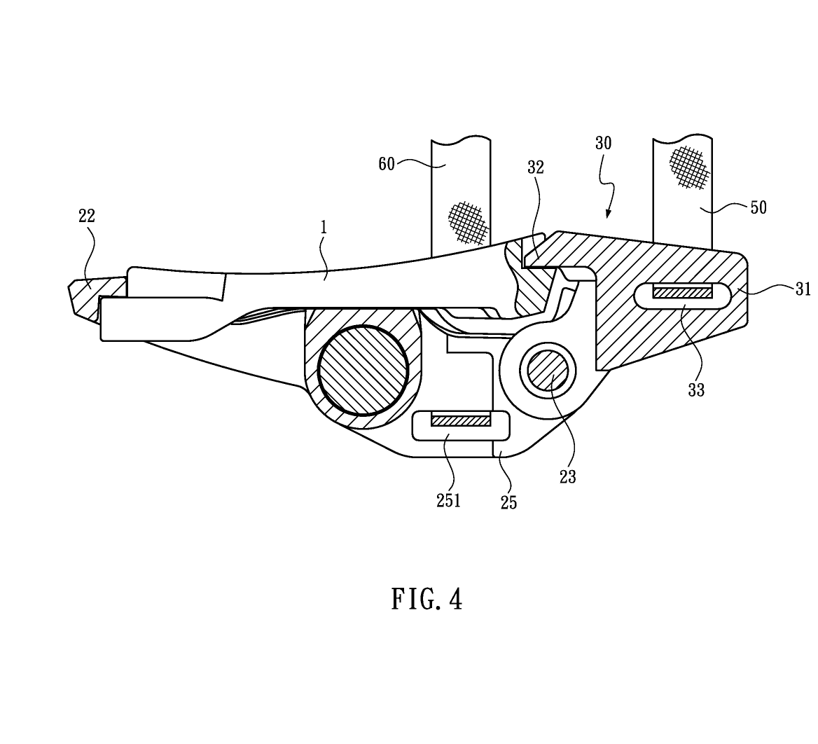

The clamping unit 30 is pivotally attached to the first end 21 of the pedal body 20 and pivotable against the axle 23 between a clamping position and a releasing position. In addition, the clamping unit 30 has a pulling portion 31 and a clamping portion 32 wherein the pulling portion 31 is farther from the second end 22 of the pedal body 20 than the clamping portion 32 is and when the clamping unit 30 pivots on the axle 23, upward tilt of the pulling portion 31 makes the clamping portion 32 point downward, and vice versa. As shown in FIG. 3, when the cyclist's shoe is first placed on the pedal of the present invention, its cleat 1 pushes the clamping unit 30 to the releasing position. After the cleat 1 is properly received by the pedal, the clamping unit 30 is returned to the clamping position in virtue of the spring means 40. At this time, as shown in FIG. 4, the clamping portion 32 engages with the cyclist's shoe cleat 1. Preferably, the pulling portion 31 is formed with a channel 33 parallel to the axle 23.

The spring means 40 serve to endow the clamping unit 30 with a tendency to return to the clamping position. In the present embodiment, the spring means 40 is a torsion spring. However, in other embodiments of the present invention, the spring means 40 may be one or more springs of a different type or elastomers possessing elastic restoring force, such as rubber, for normally biasing the clamping unit 30 toward the clamping position.

The primary strap 50 is positioned in the pulling portion 31 and looped for receiving the cyclist's shoe. For smooth entry of the shoe, the primary strap 50 preferably has a first free end 51 and a second free end 52. The first and second free ends 51, 52 are adjustably coupled with each other so as to make the primary strap 50 looped for receiving the cyclist's shoe. Moreover, in the present embodiment, the primary strap 50 passes through the channel 33 and is combined with the clamping unit 30 such that the primary strap 50 can be easily adjusted and replaced.

The secondary strap 60 is positioned in the retaining portion 25 and looped for receiving the cyclist's shoe. In the present embodiment, the secondary strap 60 passes the channel 251 and is combined with the pedal body 20.

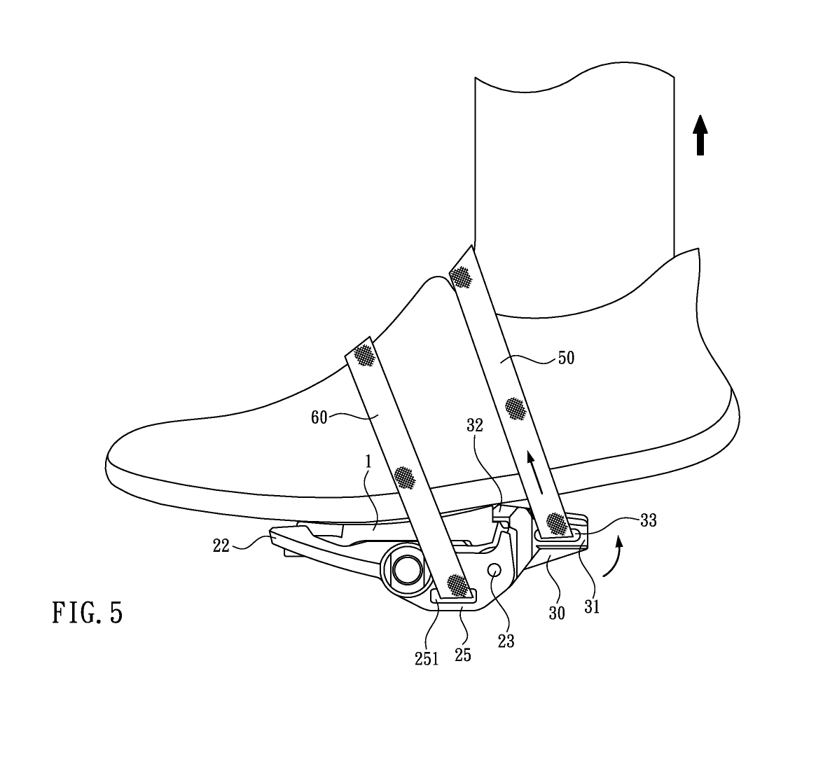

With the primary strap 50, the pedal of the present invention secures the cyclist's shoe from unintentionally disengagement. The inventor of the present invention has found that, when stepping down or pulling up a pedal, a cyclist can usually apply force with his/her thenar and maintain his/her heel higher than the thenar. The present invention therefore uses this pedaling feature, and locates the primary strap 50 that restricts the cyclist's shoe in the pulling portion 31 of the clamping unit 30. As shown in FIG. 5, since the primary strap 50 is positioned in the pulling portion 31 located beyond the axle 23, when a cyclist pulls up or step down the disclosed pedal, the pulling portion 31 is drawn upward by the primary strap 50. The moving upward of the primary strap 50 against the axle 23 thus forces the clamping unit 30 to move downward against the axle 23, thereby further enhancing the clamping force and securing the clamping unit 30 at the clamping position. As a result, the engagement between the clamping portion 32 and the shoe cleat 1 is improved. In other words, by positioning the primary strap 50 in the pulling portion 31 off the axle 23, the present invention allows that the harder the cyclist pulls up the pedal, the firmer the clamping portion 32 and the cleat 1 engage with each other, thereby effectively preventing the cleat 1 from slipping off the clamping portion 32.

Furthermore, the present invention implements the channels 251, 33 to position the primary strap 50 and the secondary strap 60, so the straps can be prevented from accidentally shifting and losing their function, and can be easily adjusted or replaced when necessary, thereby improving the practicability of the present invention.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A racing pedal for a track bicycle comprising:
a pivot connected to a crank of the track bicycle;
a pedal body pivotally connected to the pivot having a first end, a second end and an axle near the first end;
a clamping unit pivotally connected to the first end of the pedal body and pivotable against the axle between a clamping position and a releasing position, wherein when the clamping unit is at the clamping position, a clamping portion thereof engages with a cleat formed at a sole of a cyclist's shoe; and
a spring means serving to endow the clamping unit with a tendency to return to the clamping position, wherein the clamping unit has a pulling portion that is farther from the second end of the pedal body than the clamping portion is wherein when the clamping unit pivots on the axle, upward tilt of the pulling portion makes the clamping portion point downward and thereby holds the clamping unit at the clamping position, and the clamping unit has a primary strap positioned in the pulling portion for being looped to receive the cyclist's shoe.

2. The racing pedal of claim 1, wherein the pulling portion is formed with a channel parallel to the axle, so that the primary strap is partially received in the channel and thereby positioned in the pulling portion.

3. The racing pedal of claim 2, wherein the primary strap has a first free end and a second free end, wherein the first and second free ends are adjustably coupled with each other to make the primary strap looped and fit for the cyclist's shoe.

4. The racing pedal of claim 1, wherein the pedal body further includes a retaining portion, and the racing pedal further has a secondary strap, so that the secondary strap is positioned in the retaining portion for being looped to receive the cyclist's shoe.

5. The racing pedal of claim 4, wherein the pedal body further has a rotatory shaft located between the first and second ends of the pedal body and coaxial with the pivot, wherein the retaining portion is located between the first end of the pedal body and the rotatory shaft.

6. The racing pedal of claim 5, wherein the retaining portion is formed with a channel parallel to the axle, so that the secondary strap is received in the channel and thereby positioned in the retaining portion.

7. The racing pedal of claim 1, wherein the spring means comprises a torsion spring.
